(19) United States
(12) Patent Application Publication
(10) Pub. No.: US 2011/0234712 A1
(43) Pub. Date: Sep. 29, 2011

(54) Inkjet head assembly

(75) Inventors: Jae Hun Kim, Seoul (KR); Won Chul Sim, Seongnam (KR); Young Seuck Yoo, Seoul (KR); Jae Woo Joung, Suwon (KR)

(73) Assignee: Samsung Electro-Mechanics Co., Ltd., Suwon (KR)

(21) Appl. No.: 12/926,647

(22) Filed: Dec. 1, 2010

(30) Foreign Application Priority Data
Mar. 24, 2010 (KR) 10-2010-0026259

(51) Int. Cl. B41J 2/175

(52) U.S. Cl. 347/85

(57) ABSTRACT

Provided is an inkjet head assembly capable of reducing the generation of air bubbles during ink injection by using a guide formed inside an ink tank. The inkjet head assembly includes an ink tank including an ink inlet through which ink is injected from the outside, and storing ink injected through the ink inlet, an inkjet head connected with the ink tank through an ink supply channel, receiving ink from the ink tank and discharging the received ink, and a guide disposed inside the ink tank and guiding ink, injected through the ink inlet, to an inner surface of the ink tank.

### CROSS-REFERENCE TO RELATED APPLICATIONS

This application claims the priority of Korean Patent Application No. 2010-0026259 filed on Mar. 24, 2010, in the Korean Intellectual Property Office, the disclosure of which is incorporated herein by reference.

### BACKGROUND OF THE INVENTION

1. Field of the Invention

The present invention relates to an inkjet head assembly, and more particularly, to an inkjet head assembly capable of reducing the generation of air bubbles by the use of a guide, formed inside an ink tank, when ink is injected.

2. Description of the Related Art

An image forming apparatus develops a black-and-white image or a color image onto a recording medium (i.e., a printing medium), such as paper, in response to an image signal. Examples of the image forming apparatus include laser printers, inkjet printers, copy machines, multifunctional printers and fax machines. Representative image forming methods, adopted in various image forming apparatuses, may include an electron-photographic method and an inkjet method. As for the electron-photographic method, a light beam is scanned onto a photoreceptor to form an electrostatic latent image, and a developing agent is attached to the electrostatic latent image to thereby transfer the electrostatic latent image onto a printing medium. As for the inkjet printing method, liquid-phase ink is ejected onto the surface of a printing medium according to an image signal.

An inkjet image forming apparatus includes an inkjet head that ejects ink according to an image signal. As the inkjet head discharges ink droplets onto a printing medium on the basis of an image signal, a letter or an image is printed onto the printing medium. The inkjet image forming apparatus is in widespread use for printing operations, since it generates a relatively low level of noise during printing and is able to form small droplets of ink having very high density.

One type of inkjet image forming apparatus includes an inkjet head receiving ink from an ink tank, which is provided integrally or separately, a carriage scanning the inkjet head over a printing medium in a predetermined direction, a transfer unit transferring the printing medium toward the inkjet head in an orthogonal direction (sub-scanning) to the predetermined direction. The inkjet image forming apparatus forms an image by discharging ink during the scanning operation of the inkjet head.

The inkjet head of the inkjet image forming apparatus may be classified into a shuttle type print head and a so-called array type inkjet head. The shuttle type print head is spaced apart from the surface of a printing medium being transferred, and discharges ink while reciprocating in an orthogonal direction (i.e., a width direction of the printing medium) to the direction in which the printing medium is conveyed. The array type inkjet head has a length corresponding to the width of a printing medium and is capable of line printing. The array type inkjet head is capable of printing one line at a time to thereby achieve high-speed printing. Both the shuttle type inkjet head and the array type inkjet head receive ink from an ink tank that stores ink, and undesirably experience the generation of air bubbles due to a height difference between an inlet through which ink is injected and the bottom of an ink tank when ink is injected into the ink tank.

### SUMMARY OF THE INVENTION

An aspect of the present invention provides an inkjet head assembly capable of reducing the generation of air bubbles by using a guide formed inside an ink tank, when ink is injected.

According to an aspect of the present invention, there is provided an inkjet head assembly including: an ink tank including an ink inlet through which ink is injected from the outside, and storing ink injected through the ink inlet; an inkjet head connected with the ink tank through an ink supply channel, receiving ink from the ink tank and discharging the received ink; and a guide disposed inside the ink tank and guiding ink, injected through the ink inlet, to an inner surface of the ink tank.

The guide may guide the ink, injected through the ink inlet, to a bottom surface of the ink tank.

The ink tank may include: a first storage part receiving ink injected through the ink inlet; and a second storage part connected to the first storage part through at least one communication hole, maintaining a full level of ink upon receiving ink from the first storage part, and supplying ink to the inkjet head through the ink supply channel.

The guide may guide ink, injected through the ink inlet, to a bottom surface of the first storage part.

The guide may include at least one inclined surface having a preset slope from the ink inlet to the bottom surface.

The guide may include: a first inclined surface having a preset slope from the ink inlet to the bottom surface; and a second inclined surface connected with the first inclined surface, opposing the first inclined surface and having a preset slope from the ink inlet to the bottom surface.

An end portion of the first inclined surface toward the bottom surface may be connected with an end of the second inclined surface toward the bottom surface.

The ink inlet may be formed in the first storage part, and the first storage part may further include an air outlet through which inside air is discharged.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating the inside of an inkjet head assembly according to an exemplary embodiment of the present invention;

FIG. 2 is a schematic cross-sectional view illustrating the side portion of an inkjet head assembly according to an exemplary embodiment of the present invention;

FIG. 3 is a schematic cross-sectional view illustrating the side portion of an inkjet head assembly according to another exemplary embodiment of the present invention; and

FIG. 4 is a schematic cross-sectional view illustrating an inkjet head assembly according to another exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and thus their description will be omitted.

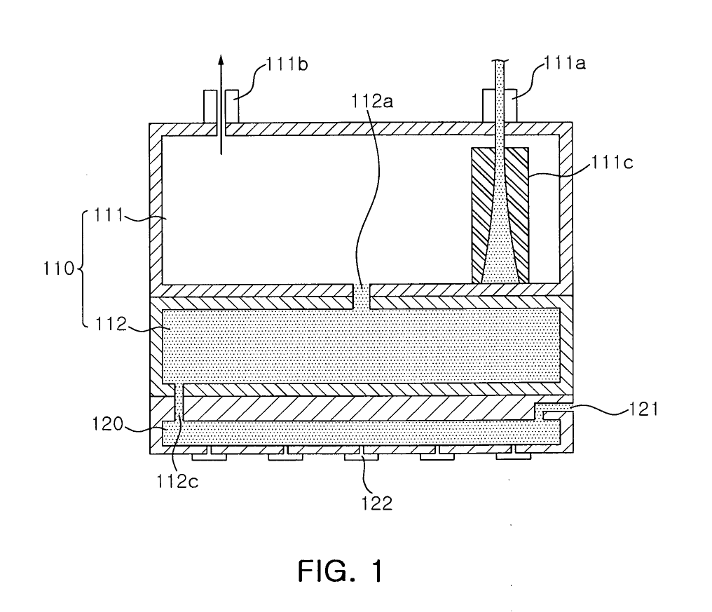

FIG. 1 is a schematic cross-sectional view illustrating the inside of an inkjet head assembly according to an exemplary embodiment of the present invention.

Referring to FIG. 1, an inkjet head assembly 100, according to this exemplary embodiment, may include an ink tank 110 and an inkjet head 120.

The ink tank 110 may include at least one storage part. As shown in FIG. 1, the ink tank 110 may include a first storage part 111 primarily receiving injected ink, and a second storage part 112 connected with the first storage part 111 through at least one communication hole 112a and maintaining a full level of ink upon receiving ink from the first storage part 111 through the communication hole 112a.

When transferred by a transfer unit (not shown) during a printing operation, an inkjet head assembly experiences pressure changes due to movements of ink stored within an ink tank 110. Such changes in pressure adversely affect the volume and speed of droplets being discharged by an inkjet head, thereby degrading print quality. However, according to this embodiment, the ink tank 110, supplying ink to the inkjet head 120, is divided into the first storage part 111 and the second storage part 112, and the second storage part 112, directly connected with the inkjet head 120, is operated to maintain its full level of ink. That is, when the inkjet head assembly moves, the second storage part 112 supresses pressure change caused by the movement of ink, so that deterioration in print quality can be minimized.

Furthermore, the first storage part 111 may have an ink inlet 115a through which ink is injected. In addition, the inkjet head 120 receives ink from the ink tank 110. If an excessive amount of ink is provided in a printing operation or ink is provided when no printing operation is performed, ink may undesirably leak from the surface of the inkjet head 120 regardless of the printing operation. This phenomenon is called wetting. In order to prevent wetting, negative pressure needs to be created between the inkjet head 120 and the ink tank 110, so that ink flows between the ink tank 110 and the inkjet head 120 only when ink is injected from the inkjet head 120. Therefore, the first storage part 111 may include an air outlet 111b that creates negative pressure between the inkjet head 120 and the ink tank 110 to thereby discharge inside air.

The inkjet head 120 is connected with the second storage part 112 by an ink supply channel 112c. Ink may be provided to the inkjet head 120 through the ink supply channel 112c while the second storage part 112 maintains its full level of ink. At the initial stage of ink injection, the inkjet head 120 may discharge ink, containing air bubbles, through an ink outlet 121 for a predetermined period of time. Thereafter, ink is discharged through a nozzle 122 provided at the lower portion of the inkjet head 120, thereby forming an image.

A guide 111c may be formed inside the first storage part 111 of the ink tank 110. The guide 111c may be formed from the ink inlet 111a to the inner surface of the first storage part 111. The guide 111c may be formed up to the bottom surface of the first storage part 111 so as to guide ink, injected through the ink inlet 111a, up to the bottom surface of the first storage part 111. One end portion of the guide 111c, placed near the bottom surface of the first storage part 111, may be spaced part from the bottom surface at a preset distance without contacting the bottom surface.

Although not shown, the ink tank 110 may have a single storage part by integrating the first storage part and the second storage part together. In this case, a person having ordinary skill in the art would easily guess, in view of the embodiment of FIG. 1, that the guide 111c can be formed from the ink inlet of the single storage part up to the bottom surface of the single storage part.

Hereinafter, operation processes of the inkjet head assembly will be described.

In general, an inkjet head assembly includes an ink head and an inkjet head that are integrally or separably provided. The separable inkjet head assembly is mounted on a transfer system (not shown) that may transfer the inkjet head assembly to a printing medium. In this case, the ink tank is mounted on the transfer system and the inkjet head is then coupled with the ink tank.

The inkjet head assembly, mounted on the transfer system (not shown), forms an image by discharging ink through a nozzle while moving along a printing surface of the printing medium.

At the initial stage of ink supply, ink supplied to the inkjet head 120 may be discharged through the ink outlet 121 for a predetermined time. This prevents ink containing air bubbles from being provided from the ink tank 110 to the inkjet head 120.

As described above, the ink tank 110 includes the first storage part 111 and the second storage part 112. The second storage part 112, connected directly to the inkjet head 120, supplies ink to the inkjet head 120 while maintaining its full level of ink. Accordingly, pressure changes, caused by movements of ink, do not occur when the inkjet head assembly is transferred for a printing operation, thereby improving print quality.

When the ink level of the first storage part 111 drops to a predetermined lowest limit or lower during the process of forming an image, ink may be injected from an ink storage unit through the ink inlet 111a formed in the first storage part 111.

In the above-stated manner, a pressure change may be effectively suppressed even if ink is supplied to the first storage part and the second storage part as ink is consumed for a printing operation.

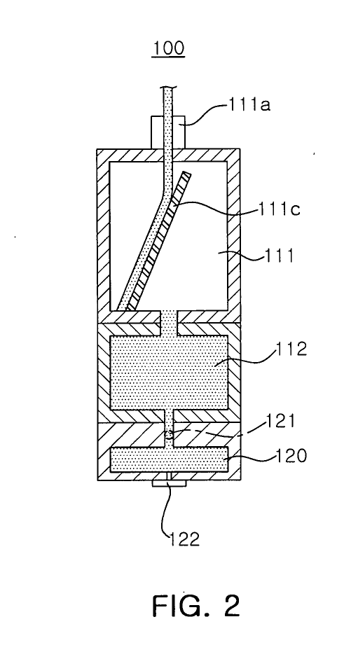

FIG. 2 is a schematic cross sectional view illustrating the side portion of an inkjet head assembly according to an exemplary embodiment.

Referring to FIGS. 1 and 2, the inkjet head assembly 100, according to this exemplary embodiment, may have a guide 111c inside the first storage part 111. The guide 111c guides ink, injected through the ink inlet 11a, to the inner portion of the first storage part 111, particularly to the bottom surface of the first storage part 111. Thus, the guide 111c may suppress bubble generation by reducing a height difference between the ink inlet 111a and the bottom surface of the first storage part 111. The guide 111c may have at least one inclined surface having a slope from the ink inlet 111a up to the bottom surface of the first storage part 111.

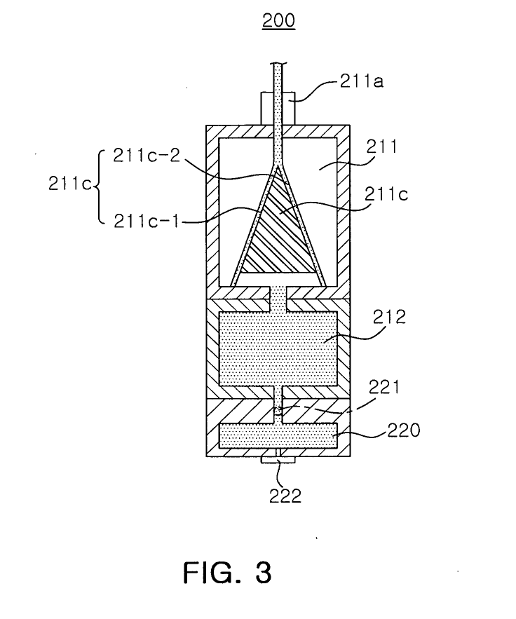

FIG. 3 is a schematic cross-sectional view illustrating the side portion of an inkjet head assembly according to another exemplary embodiment of the present invention.

Referring to FIG. 3, the inkjet head assembly 200, according to another exemplary embodiment, may include a guide 211c inside a first storage part 211. The guide 211c guides ink, injected through an ink inlet 211a, to the inner portion of the first storage part 211, particularly, to the bottom surface of the first storage part 211. Thus, the guide 211c may suppress bubble generation by reducing a height difference between the ink inlet 211 and the bottom surface of the first storage part 211. The guide 211c may have two inclined surfaces 211c-1 and 211c-2 each having a preset slope from the ink inlet 211a to the bottom surface of the first storage part 211. Further, the guide 211c may be formed as a structure having a triangular section by connecting the end portions of the two inclined surfaces 211c-1 and 211c-2. As described above, by having two inclined surfaces 211c-1 and 211c-2, the guide 211c may more stably guide ink, injected through the ink inlet 211a, to the bottom surface of the first storage part 211.

Like the inkjet head assembly depicted in FIG. 2, the ink tank 210 may include a second storage part 212. Also, an inkjet head 220 may discharge ink, containing air bubbles, through an ink outlet 221 for a predetermined time at the initial stage of ink injection, and then discharge ink through a nozzle 222 to thereby form an image.

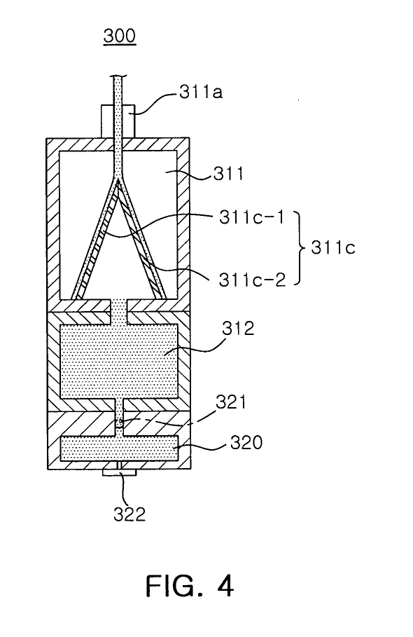

FIG. 4 is a schematic cross-sectional view illustrating the side portion of an inkjet head assembly according to another exemplary embodiment of the present invention.

Referring to FIG. 4, the inkjet head assembly 300, according to another exemplary embodiment, may include a guide 311c inside a first storage part 311. The guide 311c guides ink, injected through an ink inlet 3211a, to the inner portion of the first storage part 311, particularly, to the bottom surface of the first storage part 311. Thus, the guide 311c may suppress bubble generation by reducing a height difference between the ink inlet 311a and the bottom surface of the first storage part 311. The guide 311c may have two inclined surfaces 311c-1 and 311c-2 each having a preset slope from the ink inlet 311a to the bottom surface of the first storage part 311. Unlike the guide 211c depicted in FIG. 3, the end portions of the two inclined surfaces 311c-1 and 311c-2 are not connected so as to ensure more space for storing ink while stably guiding the ink, injected through the ink inlet 311a, to the bottom surface of the first storage part 211.

Like the inkjet head assemblies depicted in FIGS. 2 and 3, an ink tank 310 may include a second storage part 312. The inkjet head 320 may discharge ink, containing air bubbles, through an ink outlet 221 form a predetermined time at the initial stage of ink injection time, and then discharge ink through a nozzle 222 to thereby form an image.

As described above, when the inkjet head assembly is transferred, a pressure change is suppressed due to the ink tank divided into the first storage part and the second storage part, so that deterioration in print quality is minimized. Also, the guide is provided in the ink tank so as to guide injected ink to the bottom surface of the ink tank, thereby reducing a height difference between the ink inlet through which ink is injected and the inner bottom surface of the ink tank. Accordingly, bubble generation can be reduced at the time of ink injection.

As set forth above, according to exemplary embodiments of the invention, the guide formed inside the ink tank guides ink, being injected, to the inner surface of the ink tank, preferably, to the bottom surface of the ink tank, thereby reducing bubble generation.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head assembly comprising:
an ink tank including an ink inlet through which ink is injected from the outside, and storing ink injected through the ink inlet;
an inkjet head connected with the ink tank through an ink supply channel, receiving ink from the ink tank and discharging the received ink; and
a guide disposed inside the ink tank and guiding ink, injected through the ink inlet, to an inner surface of the ink tank.

2. The inkjet head assembly of claim 1, wherein the guide guides the ink, injected through the ink inlet, to a bottom surface of the ink tank.

3. The inkjet head assembly of claim 2, wherein the ink tank comprises:
a first storage part receiving ink injected through the ink inlet; and
a second storage part connected to the first storage part through at least one communication hole, maintaining a full level of ink upon receiving ink from the first storage part, and supplying ink to the inkjet head through the ink supply channel.

4. The inkjet head assembly of claim 3, wherein the guide guides ink, injected through the ink inlet, to a bottom surface of the first storage part.

5. The inkjet head assembly of claim 2, wherein the guide comprises at least one inclined surface having a preset slope from the ink inlet to the bottom surface.

6. The inkjet head assembly of claim 5, wherein the guide comprises:
a first inclined surface having a preset slope from the ink inlet to the bottom surface; and
a second inclined surface connected with the first inclined surface, opposing the first inclined surface and having a preset slope from the ink inlet to the bottom surface.

7. The inkjet head assembly of claim 6, wherein an end portion of the first inclined surface toward the bottom surface is connected with an end of the second inclined surface toward the bottom surface.

8. The inkjet head assembly of claim 3, wherein the ink inlet is formed in the first storage part, and
the first storage part further includes an air outlet through which inside air is discharged.

9. The inkjet head assembly of claim 3, wherein the guide comprises at least one inclined surface having a preset slope from the ink inlet to the bottom surface.

10. The inkjet head assembly of claim 9, wherein the guide comprises:
a first inclined surface having a preset slope from the ink inlet to the bottom surface; and
a second inclined surface connected with the first inclined surface, opposing the first inclined surface and having a preset slope from the ink inlet to the bottom surface.

11. The inkjet head assembly of claim 10, wherein an end portion of the first inclined surface toward the bottom surface is connected with an end of the second inclined surface toward the bottom surface.
